(19) United States
(12) Patent Application Publication
(10) Pub. No.: US 2021/0011469 A1
(43) Pub. Date: Jan. 14, 2021

(54) ANTENNA STRUCTURE, REMOTE CONTROLLER, AND UNMANNED AERIAL VEHICLE SYSTEM

(71) Applicant: SZ DJI TECHNOLOGY CO., LTD., Shenzhen (CN)

(72) Inventors: Liangshen CHEN, Shenzhen (CN); Xiaokai GUO, Shenzhen (CN); Yiwei CHEN, Shenzhen (CN)

(21) Appl. No.: 17/035,362

(22) Filed: Sep. 28, 2020

Related U.S. Application Data
(63) Continuation of application No. PCT/CN2018/093052, filed on Jun. 27, 2018.

(51) Int. Cl. G05D 1/00; B64C 39/02; B64C 1/36; H01Q 1/12; H01Q 1/22; G05D 1/10

(52) U.S. Cl. CPC G05D 1/0016; B64C 39/024; B64C 1/36; B64C 2201/12; H01Q 1/22; G05D 1/0022; G05D 1/101; H01Q 1/125

(57) ABSTRACT

An antenna structure includes a base, a first radiator, and a second radiator. The base is configured to be rotatably connected to a remote controller body of a remote controller of an unmanned aerial vehicle (UAV) system. One ends of the first radiator and the second radiator are connected to the base, and other ends of the first radiator and the second radiator extend away from the base. The first radiator and the second radiator are fixedly connected to the base in a rotation direction relative to the remote controller body and are configured to rotate simultaneously with the base in the rotation direction.

### CROSS-REFERENCE TO RELATED APPLICATION

This application is a continuation of International Application No. PCT/CN2018/093052, filed Jun. 27, 2018, the entire content of which is incorporated herein by reference.

### TECHNICAL FIELD

The present disclosure relates to unmanned aerial vehicle (UAV) technology field and, more particularly, to an antenna structure, a remote controller, and an unmanned aerial vehicle (UAV) system.

### BACKGROUND

The current unmanned aerial vehicle (UAV) is controlled by a remote controller. Both the UAV and the remote controller include antennas for wireless communication. For the current remote controller, a structure with two antennas is configured to send and receive signals at different frequency bands, so that the UAV can be controlled in various ways. For the current remote controller with the structure with two antennas, a technical problem exists that the two antennas cannot be folded and stored, or can only be folded and opened separately, and when the remote controller is used, the opening angle of each antenna must be adjusted separately, which is inconvenient.

### SUMMARY

Embodiments of the present disclosure provide an antenna structure, including a base, a first radiator, and a second radiator. The base is configured to be rotatably connected to a remote controller body of a remote controller of an unmanned aerial vehicle (UAV) system. One ends of the first radiator and the second radiator are connected to the base, and other ends of the first radiator and the second radiator extend away from the base. The first radiator and the second radiator are fixedly connected to the base in a rotation direction relative to the remote controller body and are configured to rotate simultaneously with the base in the rotation direction.

Embodiments of the present disclosure provide a remote controller, including a remote controller body, and an antenna structure. The antenna structure includes a base, a first radiator, and a second radiator. The base is configured to be rotatably connected to a remote controller body of a remote controller of an unmanned aerial vehicle (UAV) system. One ends of the first radiator and the second radiator are connected to the base, and other ends of the first radiator and the second radiator extend away from the base. The first radiator and the second radiator are fixedly connected to the base in a rotation direction relative to the remote controller body and are configured to rotate simultaneously with the base in the rotation direction.

### BRIEF DESCRIPTION OF THE DRAWINGS

FIG. 1 is a schematic diagram of an antenna structure according to an embodiment of the disclosure.

FIG. 2 is a schematic explosive structural diagram of an antenna structure according to an embodiment of the disclosure.

FIG. 3 is a schematic front structural diagram of an antenna structure according to an embodiment of the disclosure.

FIG. 4 is a schematic sectional structural diagram of an antenna structure along A-A direction of FIG. 3.

FIG. 5 is a schematic structural diagram of a first rotation axis according to an embodiment of the disclosure.

FIG. 6 is a schematic structural diagram of a second rotation axis according to an embodiment of the disclosure.

FIG. 7 is a schematic structural diagram of a clip member according to an embodiment of the disclosure.

FIG. 8 is a schematic structural diagram of a left joystick and a right joystick according to an embodiment of the disclosure.

FIG. 9 is a schematic structural diagram showing a remote controller in a certain status according to an embodiment of the disclosure.

FIG. 10 is a schematic structural diagram showing a remote controller in a certain status according to another embodiment of the disclosure.

FIG. 11 is a schematic structural diagram showing a remote controller in a certain status according to another embodiment of the disclosure.

FIG. 12 is a schematic structural diagram showing a remote controller in a certain status according to another embodiment of the disclosure.

FIG. 13 is a schematic structural diagram showing a remote controller in a certain status according to another embodiment of the disclosure.

### DETAILED DESCRIPTION OF THE EMBODIMENTS

Technical solutions of the present disclosure will be described in connection with the reference drawings. The described embodiments are only some of embodiments not all embodiments of the present disclosure. In accordance with embodiments of the disclosure, all other embodiments obtained by those of ordinary skill in the art without any creative work are within the scope of the present disclosure.

When a component is referred to as “fixed to” another component, the component may be directly on the other component or may have a component therebetween. When a component is referred to as “connected to” another component, the component may be directly connected to the other component or may have a component therebetween.

All technical and scientific terms used herein have the same meaning as commonly understood by one of ordinary skill in the art, unless otherwise defined. The terminology used in the specification of the present disclosure is for the purpose of describing specific embodiments and is not intended to limit the disclosure. The term “and/or” as used herein includes any or all combinations of one or more of the associated listed items.

Some embodiments of the disclosure are described in detail in connection with the reference drawings. When no conflict exists, the features of the embodiments and the embodiments described below can be combined with each other.

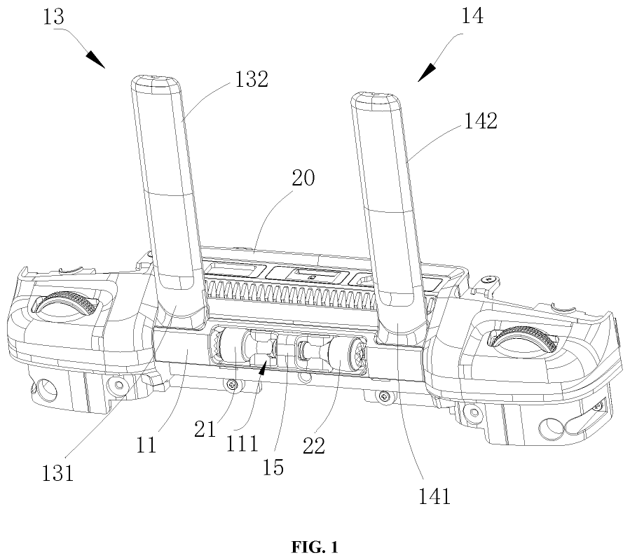

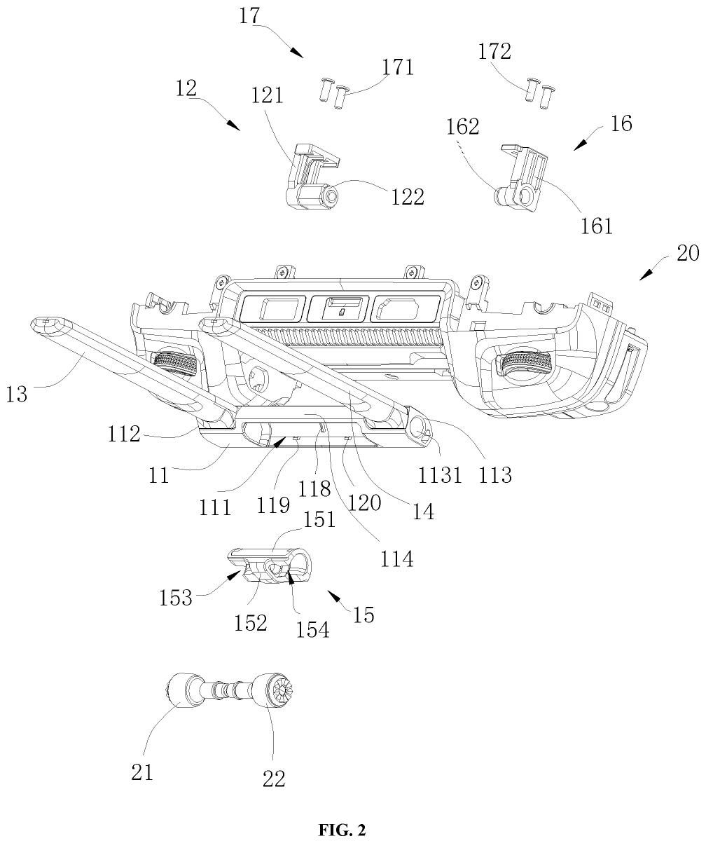

With reference to FIG. 1 and FIG. 2, in accordance with the present disclosure, there is provided an antenna structure including a base 11, a first radiator 13, and a second radiator 14. Each of the first radiator and the second radiator has one end provided at the base and another end extending in a direction away from the base. The base is rotatably connected to a body of a remote controller of an unmanned aerial vehicle (UAV). In some embodiments, the base 11 includes a first end surface 112 and a second end surface 113 opposite to each other, and a side surface 114 connected between the first end surface 112 and the second end surface 113. One end of the first radiator 13 and one end of the second radiator 14 are provided at the side surface 114 of the base 11, and the other ends extend in directions away from the base 11. The first end surface 112 and the second end surface 113 of the base are rotatably connected to the remote controller body 20 of the UAV. The base 11 rotates relative to the remote controller body 20 in a first rotation direction and drives the first radiator 13 and the second radiator 14 to rotate synchronously in the first rotation direction. In the first rotation direction, the first radiator and the second radiator are fixedly connected to the base.

Consistent with the disclosure, the first radiator 13 and the second radiator 14 are connected to the base 11, and the first radiator 13 and the second radiator 14 rotate with the base 11 in the first rotation direction. Thus, when the first radiator 13 and the second radiator 14 need to be folded or opened, an external force can be applied to the first radiator 13, the second radiator 14, or the base 11 to realize the synchronous rotation of the first radiator 13 and the second radiator 14 to reach set positions, e.g., set orientations. Compared to the radiators which need to be adjusted individually, the antenna structure of the present disclosure can allow adjustment of the positions, e.g., orientations, of the first radiator 13 and the second radiator 14 synchronously. The structure is simple, and the operation is convenient. In this disclosure, the position of a radiator, e.g., the first radiator 13 or the second radiator 14, can refer to, e.g., the orientation of the radiator, and the position of the radiator towards an object, e.g., the UAV, can refer to, e.g., the orientation of the radiator towards the object.

The antenna structure also includes a first rotation shaft 12 and a second rotation shaft 16. The first rotation shaft 12 includes a first rotation member 122 and a first fixation member 121. The first rotation member 122 is rotatably connected to the first fixation member 121. The second rotation shaft 16 includes a second rotation member 162 and a second fixation member 161. The second rotation member 162 is rotatably connected to the second fixation member 161. The first fixation member 121 and the second fixation member 161 are fixedly connected to the remote controller body 20. The first rotation member 122 penetrates through the first end surface 112 of the base 11, and the second rotation member 162 penetrates through the second end surface 113 of the base 11. With the provision of the first rotation shaft 12 and the second rotation shaft 16, and the first end surface 112 and the second end surface 113 of the base 11 cooperate with the first rotation shaft 12 and the second rotation shaft 16, respectively, rotation of the base 11 relative to the remote controller body 20 can be realized. In some embodiments, the first end surface 112 of the base 11 is configured with a first shaft hole (not shown in the figure), and the second end surface 113 is configured with a second shaft hole 1131. The axes of the first shaft hole and the second shaft hole 1131 are collinear. The first rotation member 122 is in mating connection with the first shaft hole, and the second rotation member 162 is in mating connection with the second shaft hole 1131, so that the base 11 is mounted at the remote controller body 20. In an embodiment, the second rotation member 162 is fixedly connected to the second fixation member 161, and the second rotation member 162 is movably connected to the second shaft hole 1131, where the second rotation member 162 provides a support function. In another embodiment, the second rotation member 162 is rotatably connected to the second fixation member 161, and the structure of the second rotation shaft 16 is similar to the structure of the first rotation shaft 12. The second rotation member 162 cooperates with the second shaft hole 1131 to form a rigid structure.

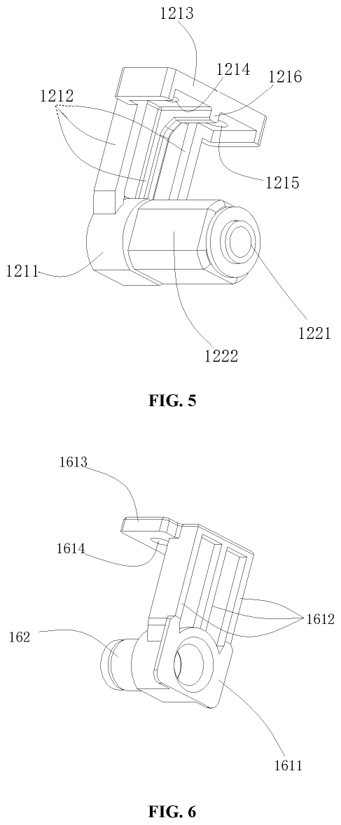

In some embodiments, as shown in, e.g., FIG. 2 and FIG. 5, the first fixation member 121 of the first rotation shaft 12 includes a first connection plate 1211, a first extension plate 1212, and a first fixation plate 1213. The first extension plate 1212 and the first fixation plate 1213 are connected to the opposite ends of the first connection plate 1211. The extension direction of the first connection plate 1211 is the same as the extension direction of the first extension plate 1212. The extension direction of the first fixation plate 1213 is at an angle with respect to the extension direction of the first extension plate 1212. In some embodiments, the extension direction of the first fixation plate 1213 and the extension direction of the first extension plate 1212 are perpendicular to each other. The first fixation plate 1213 is configured with a first connection hole 1214. A connection piece 17 is provided through the first connection hole 1214 and is fixedly connected to the remote controller body 20. To enhance the stability of the rigid connection, at least one second connection hole 1215 can be configured at the first fixation plate 1213, and the connection piece 17 includes at least two first connection pieces 171. Through the cooperation of the at least two first connection pieces 171 with the first connection hole 1214 and the at least one second connection hole 1215, the first rotation shaft 12 is fixed to the remote controller body 20. The connection piece 17 may be a structure such as a screw, a rivet, etc. The connection piece 17 is detachably connected to the remote controller body 20 to facilitate the manufacture of various components of the remote controller.

The first rotation member 122 includes a first middle shaft 1221 and a first sleeve 1222. The first sleeve 1222 is sleeved outside the first middle shaft 1221. The first middle shaft 1221 and the first sleeve 1222 are rotatably connected to each other. One end of the first middle shaft 1221 is fixedly connected to the first connection plate 1211 of the first fixation member 121. An extension direction of the first middle shaft 1221 is perpendicular to an extension plane of the first connection plate 1211. The first fixation plate 1213 of the first fixation member 121 may protrude from the first extension plate 1212 to the side of the first rotation member 122, so that the projection of the first connection hole 1214 at a plane parallel to the first fixation plate 1213 at least partially overlaps with the projection of the first rotation member 122, more specifically the first sleeve 1222, at the plane parallel to the first fixation plate 1213. As such, the center of gravity of the entire first rotation member 12, after the first fixation member 121 is connected and fixed, is more biased toward the side of the first rotation member 122. In this way, when the first sleeve 1222 of the first rotation member 122 rotates relative to the first middle shaft 1221, the torque between the first middle shaft 1221 and the first connection plate 1211 is smaller, and the lifetime of the first rotation shaft 1211 may be extended.

The cross-section of the first middle shaft 1221 is circular, and the cross-section of the first sleeve 1222 may be circular, or the inner surface of the first sleeve 1222 may be circular and the outer surface of the first sleeve 1222 may be polygonal. The inner surface of the first sleeve 1222 and the first middle shaft 1221 cooperate and form a rotation pair. The shape of the first shaft hole of the base 11 corresponds to the shape of the outer surface of the first sleeve 1222. For example, when the cross-section of the outer surface of the first sleeve 1222 is polygonal, the shape of the cross-section of the first shaft hole is also correspondingly polygonal. The first shaft hole cooperates with the first sleeve 1222 to form a rigid structure. Compared to a circular cross-section of the outer surface of the first sleeve 1222, the polygonal structure can ensure no relative sliding between the outer surface of the first sleeve 1222 and the inner surface of the first shaft hole of the base 11 to improve accuracy. Therefore, in the embodiment, the first end surface 112 of the base is rotated through the relative rotation of the rotation pair of the first sleeve 1222 and the first middle shaft 1221.

In some embodiments, the first rotation shaft 12 also includes the following characteristics. To save material, the first extension plate 1212 may adopt a hollow structure, for example, the first extension plate 1212 is formed by, but is not limited to, combining three-strip plates, with certain gaps existing between the three-strip plates and two ends of each of the three-strip plates being connected with the first connection plate 1211 and the first fixation plate 1213, respectively. To ensure the structural strength of the first connection plate 1211, the size (i.e., thickness) of the first connection plate 1211 in the direction of the first middle shaft 1221 is configured to be larger than the size of the first extension plate 1212. Further, to strengthen the connection structure between the first extension plate 1212 and the first fixation plate 1213 and reduce the stress, a first rib plate 1216 may be provided, which may be connected to the position where the first extension plate 1212 and the first fixation plate 1213 are connected to each other. To increase the structural strength of the first fixation plate 1213, the edge thickness of the first fixation plate 1213 is configured to be thicker than the thickness of the center area.

As shown in, e.g., FIG. 2 and FIG. 6, the structure of the second rotation shaft 16 is similar to the structure of the first rotation shaft 12 and includes a second fixation member 161 and a second rotation member 162. In an embodiment, the structure of the second fixation member 161 is similar to the structure of the first fixation member 121, and includes a second connection plate 1611, a second extension plate 1612, and a second fixation plate 1613. The structures of the second connection plate 1611, the second extension plate 1612, and the second fixation plate 1613 are made referred to the first connection plate 1211, the first extension plate 1212, and the first fixation plate 1213. The second fixation plate 1613 is configured with a third connection hole 1614. The structure of the third connection hole 1614 is similar to the structure of the first connection hole 1214. In an embodiment, the second rotation member 162 may have a similar structure as the structure of the first rotation member 121, and may also include a second middle shaft and a second sleeve. The second sleeve is fixedly connected to the second shaft hole 1131 of the base 11, and the second sleeve and the second middle shaft are rotatably connected. For the specific structures of the second sleeve and the second middle shaft, reference can be made to the structure of the first rotation member 121. In another embodiment, the second rotation member 162 is fixedly connected to the second connection plate 1611 of the second fixation member 161. The second rotation member 162 is cylindrical, that is, the cross-section of the outer surface is circular, and the second rotation member 162 is rotatably connected to the second shaft hole 1131 of the base 11. To reduce the friction loss between the second rotation member 162 and the second shaft hole 1131, a bearing may be provided at the outer surface of the second rotation member 162, and the bearing is mounted at the inner surface of the second shaft hole 1131. The second rotation member 162 rotates with respect to the second shaft hole 1131 through a bearing.

The base 11 may extend as a straight column, such as cylindrical, ellipsoidal, or rectangular column with rounded corners. That is, the side surface 114 of the base 11 may be a cylindrical surface, an elliptical cylindrical surface, or a combination of flat and rounded surfaces. The dimension of the cross-section of the base 11 is kept the same, so that the area when the base 11 rotates is the same, and the structure of the base 11 mounted at the remote controller body 20 can be conveniently designed. The first end surface 112 and the second end surface 113 of the base 11 may be flat, and the first end surface 112 and the second end surface 113 are perpendicular to a straight line in the extension direction of the base 11, and the first end surface 112 and the second end surface 113 are parallel, so that the structure of the base 11 is simpler and easier to facilitate the assembly of the first rotation shaft 12 and the second rotation shaft 16.

The first rotation direction in this disclosure refers to a circumferential direction about a straight line extending along the base 11. In some embodiments, the first rotation direction may be in the circumferential direction about the axis of the first shaft hole and the second shaft hole 1131, and maybe a counter-clockwise direction or a clockwise direction.

The first radiator 13, the second radiator 14, and the base 11 may be an integrated structure, that is, the first radiator 13, the second radiator 14, and the base 11 may be integrally formed by a single process. The manufacturing process may include casting, turning, milling, etc. The first radiator 13 and the second radiator 14 can also be separate parts mounted at the base 11. For example, a clip sleeve can be opened on the side surface 114 of the base 11 and the first radiator 13 and the second radiator 14 can be inserted into the clip sleeve to be fixed, or the first radiator 13 and the second radiator 14 can be mounted at the side surface 114 of the base 11 using connection pieces such as screws, rivets, etc.

The first radiator 13 and the second radiator 14 are both configured to radiate and receive electromagnetic wave signals. The object of wireless communication is the UAV. A corresponding antenna device is provided at the UAV to receive the electromagnetic wave signals from the first radiator 13 and the second radiator 14, or send the electromagnetic wave signals to the first radiator 13 and the second radiator 14. The electromagnetic wave signals sent by the remote controller to the UAV through the first radiator 13 and the second radiator 14 are control instructions, and the control instructions may include adjusting parameters such as flight speed, altitude, etc., of the UAV, and control a camera device carried by the UAV to photograph or change the photographing angle, lens focal length, etc. The first radiator 13 and the second radiator 14 are electrically connected to the chip of the remote controller and controlled by different control circuits of the chip. The electromagnetic wave signals radiated and received by the first radiator 13 and the second radiator 14 are not in the same frequency band. The frequency ranges of the electromagnetic wave signals radiated and received by the first radiator 13 and the second radiator 14 do not overlap, so that the electromagnetic wave signals radiated by the first radiator 13 and the electromagnetic wave signals radiated by the second radiator 14 do not interfere with each other and the electromagnetic wave signals can be accurately radiated to the UAV to control the UAV. When the electromagnetic wave signals are received from the UAV, similarly, the electromagnetic wave signals with different frequency bands can be received by the first radiator 13 and the second radiator 14 and be transmitted to the chip to be processed by different circuits. In this way, the flight parameter of the UAV, the photographed images, videos, etc., can be obtained. When the UAV is at a certain position, the positions, e.g., orientations, of the first radiator 13 and the second radiator 14 towards the UAV should be determined and change following the position of the UAV. When adjusting the positions of the first radiator 13 and the second radiator 14, the relative position between the first radiator 13 and the second radiator 14 is not changed. In embodiments of the disclosure, the structure of the antennas can realize the position pairing between the first radiator 13 and the second radiator 14 with the UAV at once.

In embodiments of the present disclosure, the types of the first radiator 13 and the second radiator 14 are not limited. The first radiator 13 and the second radiator 14 may be monopole antennas, inverted-F antennas, loop antennas, etc. The first radiator 13 and the second radiator 14 are made of metal. The metal may be iron, aluminum, copper, alloys, etc. To protect the metal and form a complete and uniform appearance, the outer surfaces of the first radiator 13 and the second radiator 14 are also covered with a non-metallic shell. The non-metallic shell can be made of plastic material. The use of the non-metallic shell can also prevent signal shielding of the first radiator 13 and the second radiator 14.

The first radiator 13 and the second radiator 14 are described here as an example. In some other embodiments, the base may also include a third radiator, a fourth radiator, etc. When one radiator rotates, other radiators are driven by the base 11 to also rotate together, so that the positions of the plurality of radiators can be adjusted at once.

The first radiator 13 and the second radiator 14 may be provided at any position on the side surface 114 of the base 11. The first radiator 13 is provided at one end of the base 11 near the first end surface 112. The second radiator 14 is provided at one end of the base 11 near the second end surface 113. In other words, the first radiator 13 and the second radiator 14 are positions at the base 11 that are farthest to each other, so that sufficient antenna isolation is provided between the first radiator 13 and the second radiator 14 to prevent the signals of the first radiator 13 and the second radiator 14 from cross-talking with each other and affecting the communication quality with the UAV.

In an embodiment, to simplify the overall structure of the antenna structure, the first radiator 13 and the second radiator 14 are fixedly connected to the base 11, and the extension directions of the first radiator 13 and the second radiators 14 are parallel to each other. The positions of the first radiator 13 and the second radiator 14 towards the UAV are determined, and a radiator generally has a stronger capability of radiating and receiving electromagnetic wave signals at a position corresponding to the direction to which the radiator points, i.e., the orientation of the radiator. Therefore, by configuring the extension directions of the first radiator 13 and the second radiator 14 to be parallel to each other, the orientations of the first radiator 13 and the second radiator 14 are the same, so that a higher antenna efficiency can be achieved.

In an embodiment, the first radiator 13 is rotatably connected to the base 11 in a second rotation direction, and the second rotation direction is perpendicular to the first rotation direction. Due to the increased requirements for the autonomous operability of the remote controller, in the antenna structure provided in the embodiment, the first radiator 13 is configured to rotate in the second rotation direction, so that the first radiator 13 can rotate in the second rotation direction in addition to rotate in the first rotation direction with the base 11. Since the two rotation directions are perpendicular to each other, when the first radiator 13 rotates in the second rotation direction, the rotation in the first rotation direction will not be affected. The second rotation direction refers to a direction that the first radiator 13 rotates relative to the first end surface 112 and the second end surface 113 of the base 11, with the connection position between the first radiator 13 and the side surface 114 of the base 11 as the center. In an extreme scenario, the first radiator 13 can rotate to a position parallel to the extension direction of the base 11. In this way, the first radiator 13 can be fine-tuned to achieve better wireless communication.

The second radiator 14 may be similar to the first radiator 13 and may be rotatably connected to the base 11 in the second rotation direction to adjust the position of the second radiator 14 to achieve better wireless communication. The second radiator 14 may also be fixedly connected to the base 11, which can also realize wireless communication.

As shown in FIG. 1, the first radiator 13 has a flat bar shape, and has a wider radiation area than a cylindrical bar shape. The first radiator 13 includes a first connection member 131 and a first radiation member 132. The first connection member 131 is connected to the base 11, the first radiation member 132 and the first connection member 131 have a smooth transition. In the first rotation direction, the thickness of the first radiation member 132 is smaller than the thickness of the first connection member 131. Since the first connection member 131 is connected to the base 11, when the base 11 rotates, the first connection member 131 receives a stronger force. Therefore, the thickness of the first connection member 131 is configured to be thicker than the thickness of the first radiation member 132 to provide sufficient strength. With the first radiation member 132 being thinner, not only material can be saved, but also when the base 11 rotates to a position that the first radiator 13 contacts the remote controller body 20, a smaller area is occupied, and hence the first radiation member 132 is easier to be stored at the remote controller body 20.

The second radiator 14 is similar to the first radiator 13 and includes a second connection member 141 and a second radiation member 142. The second connection member 141 is connected to the base 11. The second radiation member 142 and the second connection member 141 have a smooth transition. The thickness of the second radiation member 142 may be smaller than the thickness of the second connection member 141 in the first rotation direction.

In one embodiment, the extension directions of the first radiator 13 and the second radiator 14 are in the same plane. The connection line of the connection position between the first radiator 13 and the second radiator 14 at the base 11 is parallel to the extension straight line of the base 11. When the base 11 rotates, the distances of the first radiator 13 and the second radiator 14 relative to the remote controller body 20 are always the same. In other words, the first radiator 13 and the second radiator 14 can contact the remote controller body 20 at the same time to facilitate a better storage of the first radiator 13 and the second radiator 14.

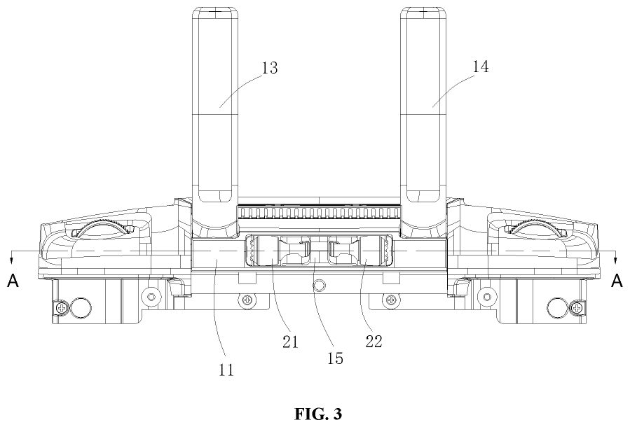

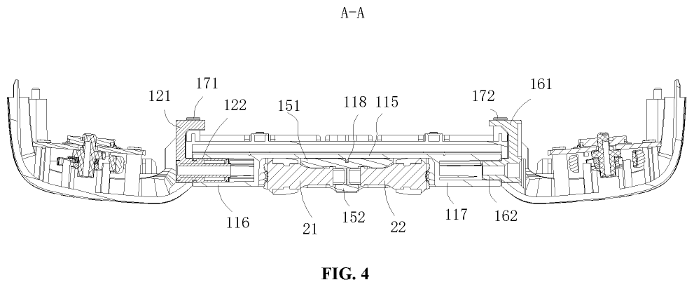

In an embodiment, as shown in FIG. 1, FIG. 2, FIG. 3, and FIG. 4, a groove 111 is formed at the base 11, and the groove 111 is provided at a position on the base 11 between the first radiator 13 and the second radiator 14. The groove 111 is configured to store joysticks of the remote controller, and has an opening through which the joysticks can be put into and taken out of the groove 111. The joysticks are structures for controlling the remote controller. The joysticks are inserted in the remote controller body 20, and the UAV is controlled by moving the joysticks. Since the joysticks protrude out of the remote controller body 20, the remote controller is not convenient to be packaged and transported. Therefore, in the embodiment, the groove 111 is formed at the base 11. When the remote controller is not used, that is, when the UAV is not in use, the joysticks are removed from the remote controller body 20 and stored in the groove 111 of the base 11 to avoid the problem of inconveniently packaging and transporting the remote controller when the joysticks protrude out of the remote controller body 20. In the embodiment, the joysticks are detachably connected to the remote controller body 20, and the connection method may include a clip connection, a thread connection, etc.

The groove 111 is formed between the first radiator 13 and the second radiator 14, that is, located in a middle part of the base 11, so as to avoid occupying the positions of the first shaft hole at the first end surface 112 and the second shaft hole 1131 at the second end surface 113 of the base 11. In some embodiments, as shown in FIGS. 2 and 4, the base 11 is divided into three sections: a first section 115 located in the middle, and a second section 116 and a third section 117 located at two sides of the first section 115, respectively. The groove 111 is formed at the first section 115. An end surface of the second section 116 away from the first section 115 is the first end surface 112, the first shaft hole is formed from the first end surface 112 into the second section 116, and the first shaft hole is used in a mating connection with the first rotation member 122 of the first rotation shaft 12. An end surface of the third section 117 away from the first section 115 is the second end surface 113, the second shaft hole 1131 is formed from the second end surface 113 into the third section 117, and the second shaft hole 1131 is used in a mating connection with the second rotation member 162 of the second rotation shaft 16. The groove 111 extends along the extension direction of the base 11. Since each of the joysticks as a whole is a linear structure, the joysticks can be placed in the groove 111 when the extension directions thereof align with the extension direction of the base 11. In some embodiments, the groove 111 is not in communication with the first shaft hole and the second shaft hole 1131, that is, separations are provided between the first shaft hole and the groove 111 and between the second shaft hole 1131 and the groove 111. The separations may be a part of the base 111 or individual structures fixedly connected to the base 11. The separations ensure individual spaces for the first shaft hole, the second shaft hole 1131, and the groove 111, ensure higher strength and rigidity of the base 11, and maintain stability when the base 11 rotates. The opening of the groove 111 is formed at the side surface 114 of the base 11 and maybe regular rectangular or irregular in a shape corresponding to the shape of the joysticks.

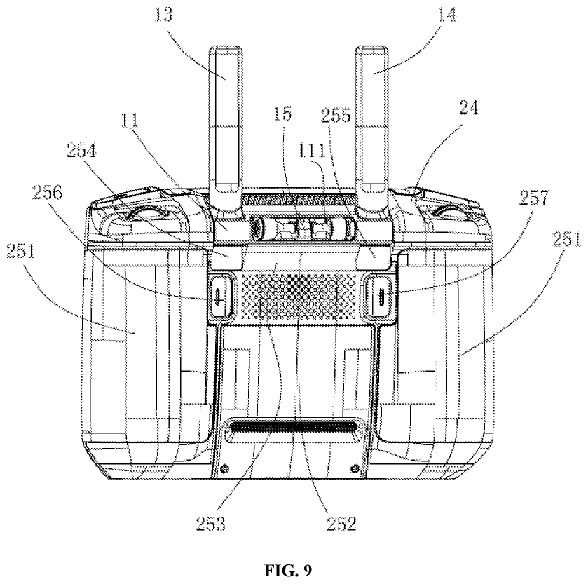

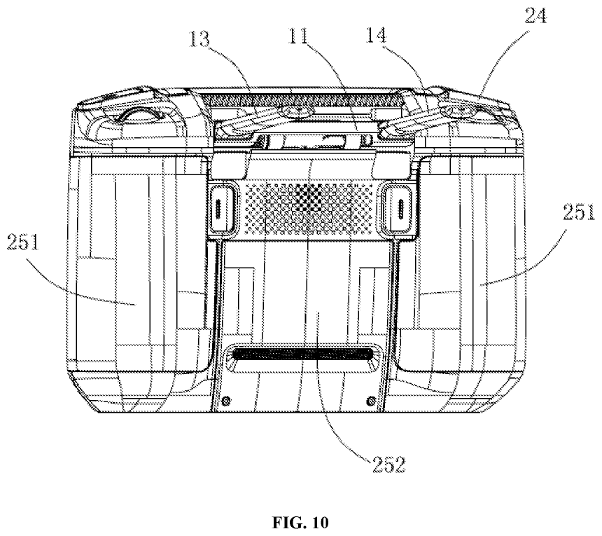

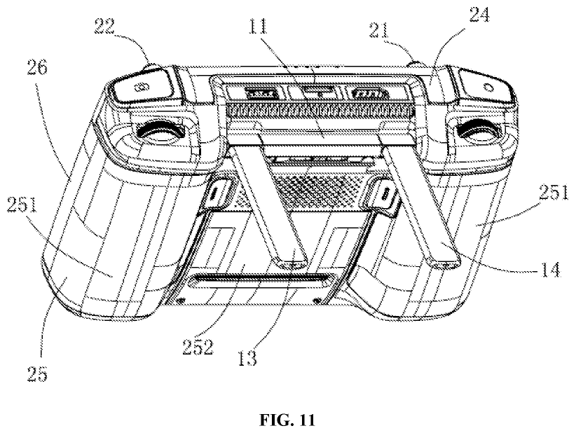

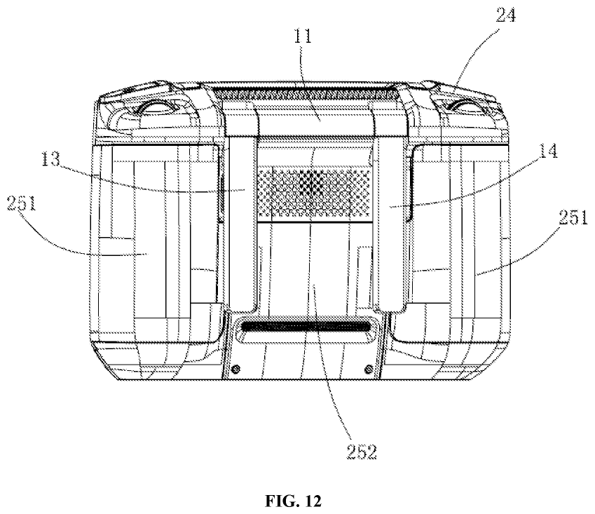

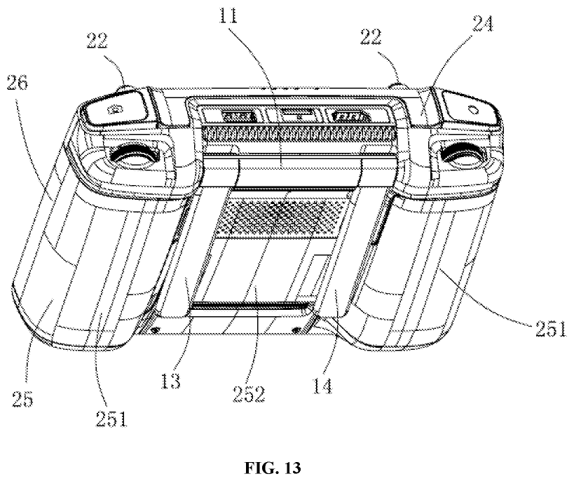

As shown in FIG. 9 to FIG. 13, when the base 11 rotates to drive the first radiator 13 to a largest opening angle relative to the remote controller body 20, the opening of the groove 111 faces away from the remote controller body 20. The opening angle of the first radiator 13 is relative to the remote controller body 20, and in some embodiments relative to the transition member 252 of the back cover of the remote controller body 20. Since the base 11 is mounted at the remote controller body 20, and the first radiator 13 extends from the base 11 in a direction away from the base 11, when the base 11 rotates to a certain position, the first radiator 13 contacts the remote controller body 20 and cannot rotate any further, so that the first radiator 13 may be at different opening angles within the range of rotation angle of the base 11. In some embodiments, the opening angle of the first radiator 13 ranges from 0° to 180°, that is, the first radiator 13 can open from a position at which the first radiator 13 contacts the remote controller body 20 to a position at which the first radiator 13 is parallel to the plane of the remote controller body 20. The opening angle of the first radiator 13 may also be described using a working state of the first radiator 13, and the working state includes a folded state, a partially opened state, and a fully opened state. When the opening angle is the smallest, such as 0°, the working state is the folded state. When the opening angle is the largest, such as 180°, the working state is the fully opened state. When the opening angle is between the smallest opening angle and the largest opening angle, such as between 0° and 180° (not equal to 0° and 180°), the working state is the partially opened state. When the remote controller is used, the opening angle of the first radiator 13 is not limited, but should not be 0°, that is, the first radiator 13 should not be in the folded state. In some embodiments, the opening angle is 90° ˜180°, and the opening angle of the first radiator 13 is relatively large. With the opening angle being in this range, the clearance area relative to the remote controller body 20 is relatively large, so that more electromagnetic wave signals may be radiated or received, and the quality of wireless communications can be improved. After the use of the remote controller, the base 11 can be rotated to the position with the largest opening angle of the first radiator 13, for example 180°, and the opening of the groove 111 at the base 11 is exposed. The joysticks are removed and placed into the groove 111 to be stored.

When the base 11 rotates to drive the first radiator 13 to the position with the smallest opening angle relative to the remote controller body 20, the first radiator 13 contacts the remote controller body 20, and the opening of the groove 111 faces the remote controller body 20. When the first radiator 13 is at the position with the smallest opening angle, for example 0°, the first radiator 13 is in the folded state, and the first radiator 13 contacts the remote controller body 20 to realize the storage of the first radiator 13. At this state, the opening of the groove 111 at the base 11 faces the remote controller body 20, the remote controller body 20 closes the opening of the groove 111 to prevent the joysticks from being dropped and lost.

The limitations of the opening angle of the first radiator 13 and the opening of the groove 111 are also applicable to the second radiator 14. In an embodiment, the extension directions of the second radiator 14 and the first radiator 13 are in the same plane, so that both the second radiator 14 and the first radiator 13 can have the largest opening angle or the smallest opening angle at the same time.

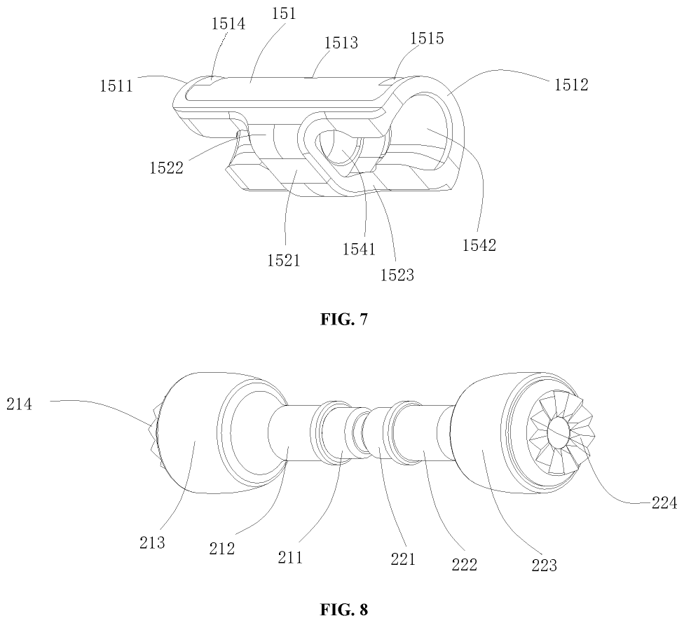

As shown in FIG. 2 and FIG. 7, a clip member 15 is provided in the groove 111. The clip member 15 includes a main body 151 and a separator 152. The main body 151 is fixedly connected to the inner surface of the groove 111. The separator 152 is formed at a side of the main body 151 that faces away from the inner surface of the groove 111, and the main body 151 and the separator 152 enclose to form a first clip groove 153. The first clip groove 153 is configured to snap the joysticks, so that the joysticks are fixed in the space of the groove 111. With the clip member 15, the joysticks are fixed in the space of the groove 111, so that when the base 11 rotates, the joysticks will not fall out of the groove 111 regardless of the opening angle of the first radiator 13.

As shown in FIG. 7, the main body 151 of the clip member 15 has a tubular structure and includes a third end surface 1511 and a fourth end surface 1512 opposite to each other. The cross-section of the main body 151 is semi-circular or arc-shaped. The outer surface of the main body corresponds to the inner surface of the groove 111, and may completely contact the inner surface of the groove 111. The inner surface of the tubular structure of the main body 151 corresponds to the outer surfaces of the joysticks. In an embodiment, the inner surface of the main body 151 is provided with a first annular boss 1541 and an extension surface 1542. The first annular boss 1541 is connected to the separator 152, and the extension surface 1542 is formed between the first annular boss 1541 and the third end surface 1511. The annular boss 1541 protrudes out of the extension surface 1542. The separator 152 of the clip member 15 includes an extension plate 1521, a first transition plate 1522, and a second transition plate 1523. The first transition plate 1522 and the second transition plate 1523 are connected to two sides of the extension plate 1521, respectively. The other end of the first transition plate 1522 is smoothly connected to the main body 151, and the other end of the second transition plate 1523 is smoothly connected to the main body 151. The outer surfaces of the extension plate 1521, the first transition plate 1522, and the second transition plate 1523 are connected to the outer surface of the main body 151. A second annular boss is formed at inner surfaces of the extension plate 1521, the first transition plate 1522, and the second transition plate 1523, and the second annular boss is connected to the first annular boss 1541 to form a complete circular annular boss structure. Side surfaces of the extension plate 1521, the first transition plate 1522, and the second transition plate 1523 are smoothly connected to each other on the two sides corresponding to the third end surface 1511 and the second end surface 1512 of the main body 151. The sizes of the extension plate 1521, the first transition plate 1522, and the second transition plate 1523 in the extension direction of the tubular structure of the main body 151 are smaller than the size of the main body 151, but larger than the size of the first annular boss 1541. The first clip groove 153 includes part of the extension surface 1542 of the main body 151, the annular boss 1541, and part of the inner surface of the separator 152. As shown in FIG. 8, take the left joystick 21 as an example, the joystick includes a plug 211, a connection rod 212, and an operation head 213 that are sequentially connected and extend along a straight line. The diameter of the plug 211 is smaller than the diameter of the connection rod 212. The diameter of the operation head 213 is larger than the diameter of the connection rod 212. When the joystick is snapped onto the first clip groove 153 of the clip member 15, the plug 211 and the connection rod 212 are first placed at the extension surface 1542, and then the joystick is pushed to insert the plug 211 into the annular boss 1541. The inner surface of the annular boss 1541 clamps the plug 211. The extension surface 1542 and a part of the inner surface of the separator 152 restrict the movement of the connection rod 212, so that the joystick is snapped onto the clip member 15, and the operation head 213 is accommodated in the space of the groove 111 outside the third end surface 1511.

In an embodiment, the separator 152 is provided at a middle part of the main body 151, so that the separator 152 and the main body 151 enclose to form the first clip groove 153 and the second clip groove 154 symmetric to each other about the separator 152. The joysticks include a left joystick 21 and a right joystick 22, and the first clip groove 153 and the second clip groove 154 are configured for clamping the left joystick 21 and the right joystick 22, respectively. In general, the remote controller is provided with two joysticks, that is, the left joystick 21 and the right joystick 22, and the left joystick 21 and the right joystick 22 are configured to implement different operation controls. The clip member 15 can clamp the left joystick 21 and the right joystick 22, so that both the left joystick 21 and the right joystick 22 are stored in the groove 111 and do not fall.

As shown in FIG. 7 and FIG. 8, the structures of the left joystick 21 and the right joystick 22 are the same, that is, the right joystick 22 also includes a plug 221, a connection rod 222, and an operation head 223. To increase the friction and have a good appearance for the joystick, the operation head 213 of the left joystick 21 and the operation head 223 of the right joystick 22 may further include a texture structure 214 and a texture structure 224, respectively, and the shape and structure of the texture structures are not limited. Similar to the previous embodiment, the left joystick 21 and the right joystick 22 are clamped in the first clip groove 153 and the second clip groove 154, respectively, where the plug 211 of the left joystick 21 and the plug 221 of the right joystick 22 are placed facing each other. The structure formed by the left joystick 21 and the right joystick 22 is arranged along a straight line so as to be accommodated in the groove 111.

As shown in FIG. 2, FIG. 4, and FIG. 7, in an embodiment, the inner surface of the groove 111 is provided with a first connection piece 118, the main body 151 is provided with a second connection piece 1513, and the clip member 15 is in mating connection to the inner surface of the groove 111 through the first connection piece 118 and the second connection piece 1513. The first connection piece 118 and the second connection piece 1513 are a detachable connection structure. For example, the first connection piece 118 may be a first protrusion, and the second connection piece 1513 may be a first groove, and the first protrusion is engaged with the first groove, or the first connection piece 118 and the second connection piece 1513 may be adhesive clothes, and two adhesive clothes are bonded together. In another embodiment, the clip member 15 and the base 11 are formed in one piece, that is, the clip member 15 is fixed to the inner surface of the groove and is an undetachable structure.

In the embodiment with the first protrusion engaged with the first groove, to strengthen the connection between the connection piece 15 and the inner surface of the groove 111, a second protrusion 119 and a third protrusion 120 are also provided at the inner surface of the groove 111. A second groove 1514 and a third groove 1515 are formed at the main body 151 of the clip member 15. The second protrusion 119 is engaged with the second groove 1514 and the third protrusion 120 is engaged with the third groove 1515 to fix the clip member 15 to the inner surface of the groove 111.

In an embodiment, as shown in FIG. 2 and FIG. 9 to FIG. 13, the first rotation member 122 of the first rotation shaft 12 is configured with shift positions, and each shift position is configured with a pre-compression angle. Within the range of the pre-compression angle, the first rotation member 122 has a tendency to rotate toward the shift position. When the first rotation member 122 rotates to the position of the shift position, the base 11 is driven to a preset fixed position. By setting the shift position, the base 11 rotates to the position of the shift position to be fixed to the position, so when the remote controller is used, the position of the base 11 only needs to be adjusted in the range of the pre-compression angle of the shift position, the base 11 rotates automatically to the fixed position for an easier operation. In some embodiments, take the opening angle and working state of the first radiator 13 as examples, the radiator 13 has the smallest opening angle and the largest opening angle, e.g., 0° ˜180°. The working state includes the folded state, the partially opened state, and the fully opened state. When the first radiator 13 is at the position with an optimum operation angle of 150°, the working state is the partially opened state. For example, a shift position is at the opening angle of the first radiator 13 of 150° and the pre-compression angle is ±10°, then when the opening angle of the first radiator 13 is any angle between 140° and 160°, the first radiator 13 has the tendency to rotate to the position with the opening angle of 150°, and is finally fixed to the position at 150°. The shift position is not limited to the position with the opening angle of 150°, and the pre-compression angle is also not limited to ±10°. The pre-compression angle can be in the range of ±5°±30°.

In some embodiments, there are more than two shift positions, and each shift position is configured with a pre-compression angle. The first rotation member 122 rotates to realize the more than two shift positions of the base. Since the first radiator 13 and the second radiator 14 may have a plurality of preferable opening angles, by setting more than two shift positions, the base 11, the first radiator 13, and the second radiator 14 may be fixed at one of a plurality of fixed positions.

There is a shift position respectively when the first radiator 13 is at the smallest opening angle or at the largest opening angle, that is, the first radiator 13 is at the folded state or at the fully opened state. Each of the two operation states is configured with a shift position with a pre-compression angle. For example, when the opening angle of the first radiator 13 is 0°, the first radiator 13 is at the folded state, and the pre-compression angle is set to 5°, the first radiator 13 rotates to 0° position with the opening angle between 0°˜5° until being fixed at the 0° position. Similarly, when the opening angle of the first radiator 13 is 180°, the first radiator 13 is at the fully opened state, and the pre-compression angle is set to −5°, the first radiator 13 rotates to 180° position with the opening angle between 175°˜180° until being fixed at the 180° position.

The present disclosure further provides an unmanned aerial vehicle (UAV) system, which includes a UAV and various remote controllers provided in embodiments of the present disclosure. The remote controller of the UAV system is provided with a base 11, and a first radiator 13 and a second radiator 14 that can rotate synchronously. The structure is simple, and the operation is convenient.

Referring to FIG. 1 to FIG. 13, embodiments of the present disclosure further provide a remote controller, which includes a remote controller body 20 and the antenna structure described in the above-described embodiments. The first end surface 112 and the second end surface 113 of the base are rotatably connected to the remote controller body 20 of the UAV. The antenna structure of embodiments of the present disclosure may rotate relative to the remote controller body 20. The positions of the first radiator 13 and the second radiator 14 of the antenna structure may be adjusted synchronously. As such, compared to adjusting the position of each radiator individually, the structure is simple, and the operation is convenient.

Referring to FIG. 9 to FIG. 13, the remote controller body 20 includes a top cover 24 and a back cover 25. The top cover 24 is provided at the top of the back cover 25, and the back cover 25 is connected to a side of the top cover 24. The base 11 is rotatably connected to the top cover 24. In some embodiments, the base 11 is provided at the top cover 24 on a side close to the back cover 25. The base 11 is rotatably connected to any position of the top cover 24. In some embodiments, the base 11 is rotatably connected to a position on the side close to the back cover 25, and no joystick for operating the remote controller is provided at the back cover 25. Therefore, the base 11 may rotate to drive the first radiator 13 and the second radiator 14 to rotate in a space where the back cover 25 is located, and the rotation does not interrupt the operation of the remote controller. Other subsidiary structures may be provided at the top cover 24 and the back cover 25, such as a heat dissipation structure, an operation button, a dial wheel, etc., which are not repeated here.

In some embodiments, the back cover 25 is provided with a transition member 252 and two handheld members 251. The two handheld members 251 are located at two side edges of the back cover 25 that are opposite to each other, respectively, and the transition member 252 is provided between the two handheld members 251. The two handheld members 251 protrude from the transition member 252. When the base 11 rotates to cause the first radiator 13 of the base 11 to be at a position with the smallest opening angle relative to the remote controller body 20, the first radiator 13 contacts the transition member 252, and the protrusion height of the first radiator 13 in the direction perpendicular to the transition member 252 is not higher than the heights of the two handheld members 251. The cross-sections of the two handheld members 251 are arc-shaped and form grip handles, which are convenient for the users to hold with fingers of both hands. The two handheld members 251 protrude from the transition member 252, so that the transition member 252 forms a recess structure relative to the two handheld members 251. When the first radiator 13 rotates to have the smallest opening angle, the first radiator 13 contacts the transition member 252, and the height of the first radiator 13 does not exceed the heights of the two handheld members 251. As such, the first radiator 13 is accommodated. The remote controller may be placed on the desk with the back cover 25 facing the desk. Thus, the remote controller does not compress the first radiator 13 to deform, and is convenient to be packaged and transported. In some embodiments, since the second radiator 14 is in the same plane with the extension plane of the first radiator 13, the second radiator 14 and the first radiator 13 may rotate synchronously and contact the transition member 252.

The structure of the top cover 24 may also correspond to the back cover 25, that is, the middle portion of the top cover 24 are recessed relative to both sides. When the base 11 is mounted at the top cover 24, the first radiator 13 and the second radiator 14 are located in the edge area of the middle portion. As such, the first radiator 13 and the second radiator 14 may contact the transition member 252 to be accommodated corresponding to the position of the transition member 252.

Referring to FIG. 9 and FIG. 1, to support the base 11 and limit the position of the base 11, to avoid excessive displacement of the rotation axis after too many rotations of the base 11, a position limiter 253 is provided at a position of the transition member 252 close to the base 11. The position limiter 253 protrudes relative to the transition member 252. The extension direction of the position limiter 253 is the same as the extension direction of the base 11. A relatively small gap exists between a surface of the position limiter 253 near the side surface 114 of the base 11 and the side surface 114 of the base 11 to reserve a margin for the rotation of the base 11. After the base 11 rotates many times, the side surface 114 of the base 11 may contact the position limiter 253. Since the position limiter 253 restricts the extension axis of the base 11 from further displacement, the accuracy of the rotation of the base 11 needed during operation may be ensured. To cause the first radiator 13 and the second radiator 14 to contact the transition member 252, a fourth groove 254 and a fifth groove 255 are provided at the position limiter 253 corresponding to the positions of the first radiator 13 and the second radiator 14. The fourth groove 254, and the fifth groove 255 are opened to be coplanar with the surface of the transition member 252. When the first radiator 13 and the second radiator 14 rotate to contact the transition member 252, a first connection member 131 of the first radiator 13 is accommodated in the fourth groove 254, and the second connection member 141 of the second radiator 14 is accommodated in the fifth groove 255. To cause the first radiator 13 and the second radiator 14 to contact the transition member 252 with soft contacts and reduce a damage risk, a first pad 256 and a second pad 257 are provided at the transition member 252. The first pad 256 and the second pad 257 correspond to the positions of the first radiator 13 and the second radiator 14 contacting the transition member 252, respectively. In some embodiments, the first pad 256 corresponds to the first radiation member 132 of the first radiator 13, and the second pad 257 corresponds to the second radiation member 142 of the second radiator 14. The materials for the first pad 256 and the second pad 257 both are soft materials such as silicone, leather, etc. As such, when the first radiator 13 and the second radiator 14 contact the transition member 252, the soft contact is realized.

The remote controller further includes a front cover 26. The front cover is provided opposite to the back cover 25. The top cover 24 is away from a side of the back cover 25 and connected to the front cover 26. The front cover 26 is provided with an operation member (not shown in the figure), and the operation member is provided with a joystick. The joystick is configured to control the remote controller. The front cover 26 is provided with the operation member. Thus, operating the remote controller may be performed at the front cover 26. The operation of the remote controller is implemented by swinging the joystick, such that the antenna structure does not affect the control of the remote controller. Besides the joystick, the operation member may be further provided with an operation button, a display, etc.

The remote controller further includes a bottom cover. The bottom cover is connected to a position between the front cover 26 and the back cover 25. The bottom cover and the top cover 24 are provided opposite to each other. The bottom cover, the top cover 24, the front cover 26, and the back cover 25 are configured to form a complete structure of the remote controller body 20. A structure such as a chip, a circuit, a connection wire, etc. may be provided in the remote controller body 20. The remote operation of the remote controller may be realized through the cooperation of the various components of the remote controller body 20.

In some embodiments, the joystick is detachably connected to the operation member.

When the UAV is grounded, the groove 111 of the base 11 is configured to accommodate the joystick detached from the operation member. The joystick may be placed into and taken out the groove 111 through the opening. The joystick is detachably designed. The joystick may be accommodated to reduce a protrusion structure of the remote controller body 20 for convenient packaging and transportation.

Referring to FIG. 2 and FIG. 8, for example, the joystick 21 includes the plug 211, the connection rod 212, and the operation head 213, which are sequentially connected and extend along a straight line as a whole. The plug 211 is configured to be connected to the operation member. After the plug 211 is removed from the operation member, the joystick 21 is accommodated in the groove 111 of the base 11. The clip member 15 in the groove 111 is provided with a first clip groove 153, which is configured to clamp the plug 211 and the connection rod 212. The extension direction of the connection rod 212 is the same as the extension direction of the base 11.

In general, the joystick includes a left joystick 21 and a right joystick 22. When the left joystick 21 and the right joystick 22 are accommodated in the groove 111, the left joystick 21 and the right joystick 22 are clamped in the first clip groove 153 and the second clip groove 154, respectively. The plug 211 of the left joystick 21 and the plug 221 of the right joystick 22 are oppositely provided. The extension directions of the left joystick and the right joystick are in a straight line. With this setup, the left joystick 21 and the right joystick 22 may be accommodated in the groove 111 and may not interfere with the rotation of the base 11.

The antenna structure, the remote controller, and the UAV of embodiments of the present disclosure are described in detail. Specific examples are used to describe the theory and embodiments of the present disclosure. The above embodiments are merely used to help to understand the methods and the core ideas of the present disclosure. Those of ordinary skill in the art can modify specific embodiments and application scope according to the spirit of the present disclosure. In summary, the specification should not be considered to limit the present disclosure.

What is claimed is:

1. An antenna structure comprising:
a base configured to be rotatably connected to a remote controller body of a remote controller of an unmanned aerial vehicle (UAV) system; and
a first radiator and a second radiator, one ends of the first radiator and the second radiator being connected to the base and other ends of the first radiator and the second radiator extending away from the base;
wherein the first radiator and the second radiator are fixedly connected to the base in a rotation direction relative to the remote controller body and are configured to rotate simultaneously with the base in the rotation direction.

2. The antenna structure of claim 1, wherein:
the first radiator is provided close to a first end surface of the base; and
the second radiator is provided close to a second end surface of the base that is opposite to the first end.

3. The antenna structure of claim 1, wherein:
the rotation direction is a first rotation direction; and
the first radiator is rotatably relative to the base in a second rotation direction perpendicular to the first rotation direction.

4. The antenna structure of claim 1, wherein:
the first radiator includes:
a connection member connected to the base; and
a radiation member connected to the connection member, a transition between the connection member and the radiation member being smooth; and
in the rotation direction, a thickness of the radiation member is smaller than a thickness of the connection member.

5. The antenna structure of claim 1, wherein extension directions of the first radiation member and the second radiation member are in a same plane.

6. The antenna structure of claim 1, wherein:
the base includes a groove between the first radiator and the second radiator;
the groove includes an opening;
the groove is configured to accommodate a joystick of the remote controller; and
the opening is configured to allow the joystick to be placed into and taken out of the groove through the opening.

7. The antenna structure of claim 6, wherein when the first radiator is at a position with a largest opening angle relative to the remote controller body, the opening of the groove faces away from the remote controller body.

8. The antenna structure of claim 6, wherein when the first radiator is at a position with a smallest opening angle relative to the remote controller body, the first radiator contacts the remote controller body and the opening of the groove faces the remote controller body.

9. The antenna structure of claim 6, wherein;
a clip member is formed in the groove, the clip member including:
a main body fixedly connected to an inner surface of the groove; and
a separator formed at a side of the main body facing away from the inner surface of the groove; and
the main body and the separator enclose to form a clip groove configured to clamp the joystick to fix the joystick in the groove.

10. The antenna structure of claim 9, wherein:
the separator is provided at a middle part of the main body, the separator and the main body enclosing to form a first clip groove and a second clip groove symmetric to each other about the separator;
the joystick is one of a left joystick and a right joystick of the remote controller; and
the first clip groove and the second clip groove are configured to clamp the left joystick and the right joystick, respectively.

11. The antenna structure of claim 9, wherein:
the inner surface of the groove is provided with a first connection piece;
the main body is provided with a second connection piece;
the clip member and the inner surface of the clip groove are in mating connection through the first connection piece and the second connection piece; and
the first connection piece and the second connection piece form a detachable structure.

12. The antenna structure of claim 1, further comprising:
a first rotation axis including:
a fixation member configured to be fixedly connected to the remote controller body; and
a first rotation member rotatably connected to the first fixation member; and
a second rotation axis including:
a second fixation member configured to be fixedly connected to the remote controller body; and
a second rotation member connected to the second fixation member;
wherein:
the base includes a first end surface and a second end surface opposite to each other;
the first rotation member is provided at the first end surface of the base; and
the second rotation member is provided at the second end surface of the base.

13. The antenna structure of claim 12, wherein:
the first rotation member is configured with a shift position having a pre-compression angle, the shift position being configured to cause the first rotation member to rotate to a fixed position corresponding to the shift position when the first rotation member is within a range of the pre-compression angle.

14. The antenna structure of claim 13, wherein:
the shift position is one of two or more shift positions of the first rotation member each having a corresponding pre-compression angle.

15. A remote controller comprising:
a remote controller body; and
an antenna structure including:
a base rotatably connected to the remote controller body; and
a first radiator and a second radiator, one ends of the first radiator and the second radiator being connected to the base and other ends of the first radiator and the second radiator extending away from the base;
wherein the first radiator and the second radiator are fixedly connected to the base in a rotation direction relative to the remote controller body and are configured to rotate simultaneously with the base in the rotation direction.

16. The remote controller 15, wherein:
the remote controller body includes a top cover and a back cover;
the top cover is provided at a top of the back cover;
the back cover is connected to a side of the top cover; and
the base is rotatably connected to the top cover.

17. The remote controller of claim 16, wherein:
the back cover includes:
two handheld members at two side edges of the back cover that are opposite to each other, respectively;
a transition member between the two handheld members;
the two handheld members protrude from the transition member;
when the first radiator is at a position with a smallest opening angle relative to the remote controller body, the first radiator contacts the transition member; and
in a direction perpendicular to the transition member, a height of a part of the first radiator protruding over the transition member is not higher than heights of parts of the two handheld members protruding over the transition member.

18. The remote controller of claim 16, further comprising:
a front cover opposite to the back cover;
wherein:
a side of the top cover away from the back cover is connected to the front cover; and
the front cover includes an operation member including a joystick configured to control and operate the remote controller.

19. The remote controller of claim 18, wherein:
the base includes a groove between the first radiator and the second radiator;
the groove is configured with an opening;
the joystick is detachably connected to the operation member; and
the groove is configured to accommodate the joystick detached from the operation member, and the joystick is placed into and taken out of the groove through the opening.

20. The remote controller of claim 19, wherein:
when the first radiator is at a position with a largest opening angle relative to the remote controller body, the opening of the groove faces away from the remote controller body; and
when the first radiator is at a position with a smallest opening angle relative to the remote controller body, the first radiator contacts the remote controller body and the opening of the groove faces the remote controller body.
